(19) United States
(12) Patent Application Publication
(10) Pub. No.: US 2006/0279652 A1
(43) Pub. Date: Dec. 14, 2006

(54) Display panel with camera function

(76) Inventors: Shou-An Yang, Tainan City (TW); Hsiang-Yuan Yang Chen, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/150,202

(22) Filed: Jun. 13, 2005

(51) Int. Cl. H04N 5/222

(52) U.S. Cl. 348/333.01

(57) ABSTRACT

A display panel with camera function has a camera module built in an extension area of a surface plate of the display panel. The circuit of the camera module is integrated with a circuit of a display module, and signals are transmitted through a single signal transmission unit. The appearance of the display panel facilitates diversified design to allow easier assembly of the camera module and much better sense of vision.

### BACKGROUND OF THE INVENTION

(a) Field of the Invention

The present invention relates to a display panel with camera function, and more particularly a display panel having a camera module built in an extension area of a surface plate of the display panel. The circuit of the camera module is integrated with a circuit of a display module, and signals are transmitted through a single signal transmission unit.

(b) Description of the Prior Art

Whereas most of the 3C products generally available in the market feature that a single product is integrated with multiple functions, the cellular phone incorporated with digital camera is the best example. Wherein, a digital camera lens is mounted onto the casing of the cellular phone. Furthermore, to facilitate the PC user to conduct digital conference via Internet, a digital camera lens is mounted to the frame of a liquid crystal display (LCD).

In those products described above, they are adapted with the digital camera or video camera functions. However, the digital camera module is independent, meaning there are an independent circuit board and a signal transmission unit. The manufacturer of the finished product has to mount the digital camera lens to the casing of the product and connect the circuit signal transmission unit to the circuit board of the main unit.

Accordingly, an extra workstation is required in the process of the assembly of the digital camera to result in increased work hours and production costs; and the signal transmission unit of the digital camera module would have to occupy the connection port otherwise reserved for the circuit board of the main unit thus to reduce the mechanism of the main unit to enjoy externally connected expansion of resources. Furthermore, the digital camera module has to be squeezed into a limited space of the casing of the product to cause additional limitation to the design of the finished product while leaving a significant protrusion to its appearance to damage the aesthetic aspect of the finished product.

On the other hand, the surface plate of the display panel for the display or the cellular phone must be made of transparent material to facilitate light emission, and the perimeter of the display panel is always fixed to a frame or in the casing of the cellular phone. The camera module can be provided at where other than the frame of the display or the casing of the cellular phone. However, up to now, the attempt of having the camera module mounted in the surface plate of the display panel has not yet been seen.

Quite obviously, the prior art of having the camera module mounted to the frame (or casing) of the display panel brings many flaws to the manufacturers of products adapted with the display panel including difficult assembly, increased production costs, taking too much resources of the main unit, and limited design for the appearance to deliver shattered visual impression to its user.

### SUMMARY OF THE INVENTION

The primary purpose of the present invention is to provide a display panel with camera function to facilitate assembly of a camera module, lower production cost, maintain resources of the main unit, present better view of the appearance of the display panel, and allow more diversified design of the appearance of the product.

To achieve the purpose, the present invention includes a camera module built in an extension area of a surface plate of the display panel; and the circuit of the camera module is integrated with a circuit of a display module; and the signals are transmitted through a single signal transmission unit. The present invention provides the following advantages:
1. Facilitated development and design of the finished product as the camera module is integrated with the display panel.
2. In assembly of the finished product, the installation of the display panel means the camera module is installed at the same time.
3. The present invention consumes very limited resources of the main unit to facilitate the expansion of the functions of the finished product.

### BRIEF DESCRIPTION OF THE DRAWINGS

FIG. 1 is a front view of the present invention.

FIG. 2 is a sectional view taken from A-A of FIG. 1.

FIG. 3 is a schematic view showing the present invention applied to a cellular phone.

FIG. 4 is a schematic view showing the present invention applied to a PDA.

FIG. 5 is a schematic view showing the present invention applied to an LCD.

FIG. 6 is a schematic view showing the present invention applied to a dual-lens product.

FIG. 7 is a schematic view showing the present invention applied to a product provided with a photoflash.

### DETAILED DESCRIPTION OF THE PREFERRED EMBODIMENTS

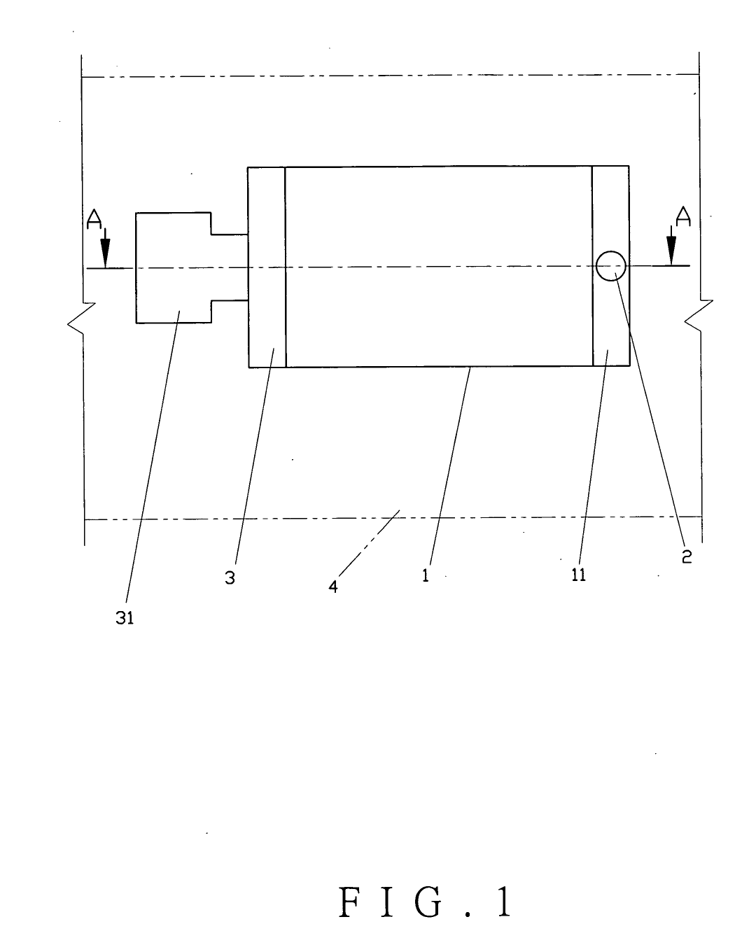

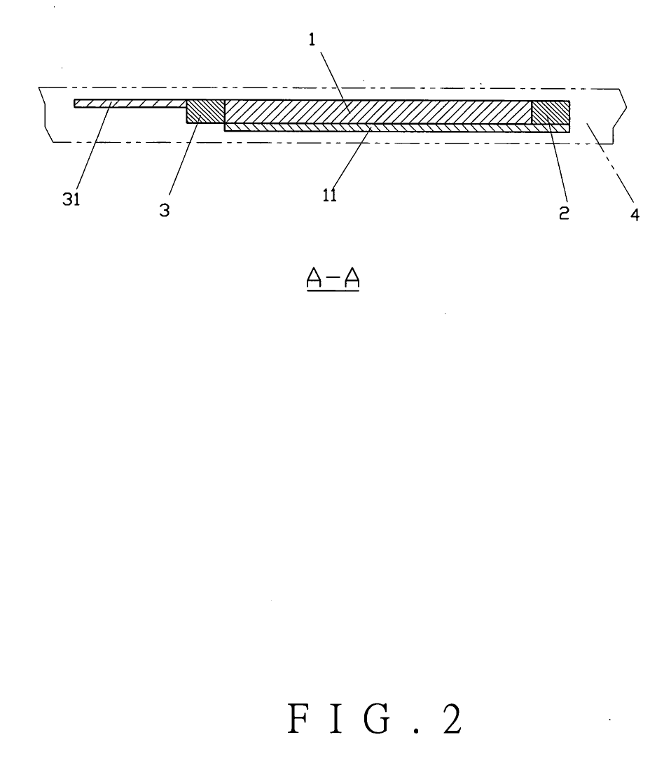

Referring to FIGS. 1 and 2, an extension area (11) is provided to a surface plate of a display panel (1) and a camera module (2) is built in the extension area (11). The circuit of the camera module (2) is integrated with a circuit of a display module into a circuit board (3) and signals are transmitted through a single signal transmission unit (31). All the components described above are installed on a support member (4). The support member (4) may be a frame or a casing of a finished product for the present invention to become a module. The surface of the extension area (11) is coated leaving only a lens area to permit the light. Accordingly, as the visual impression is concerned, the installation of a camera lens can hardly be observed to allow better visual impression to the user since only the display area is in vision. As for the manufacturer of the finished product adapted with the display panel, the present invention allows easier assembly of the camera module and diversified design for the appearance of the finished product.

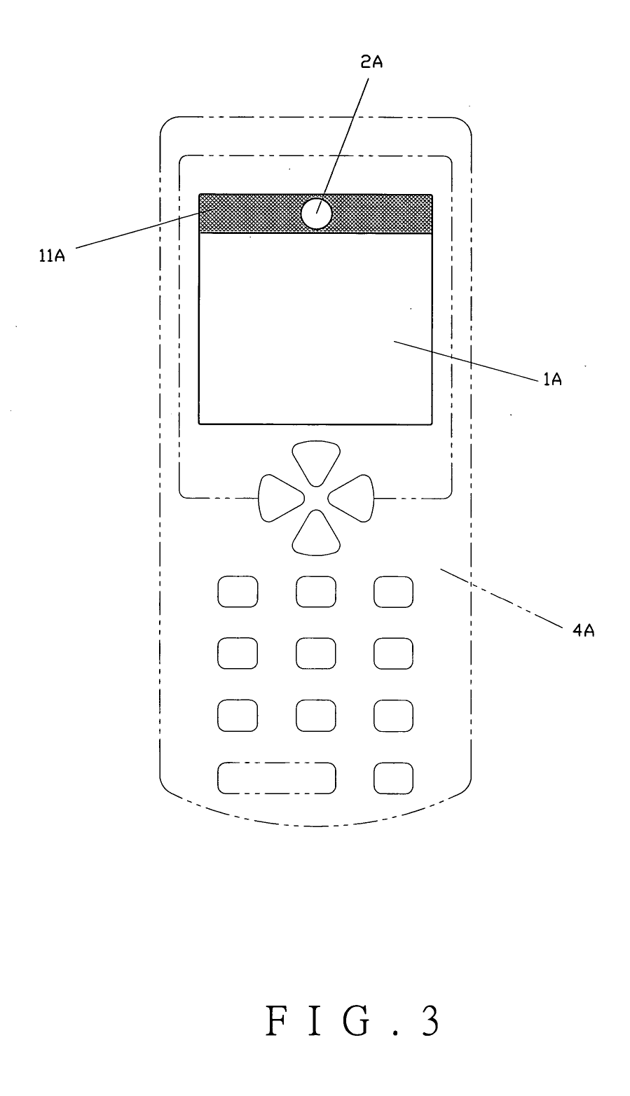

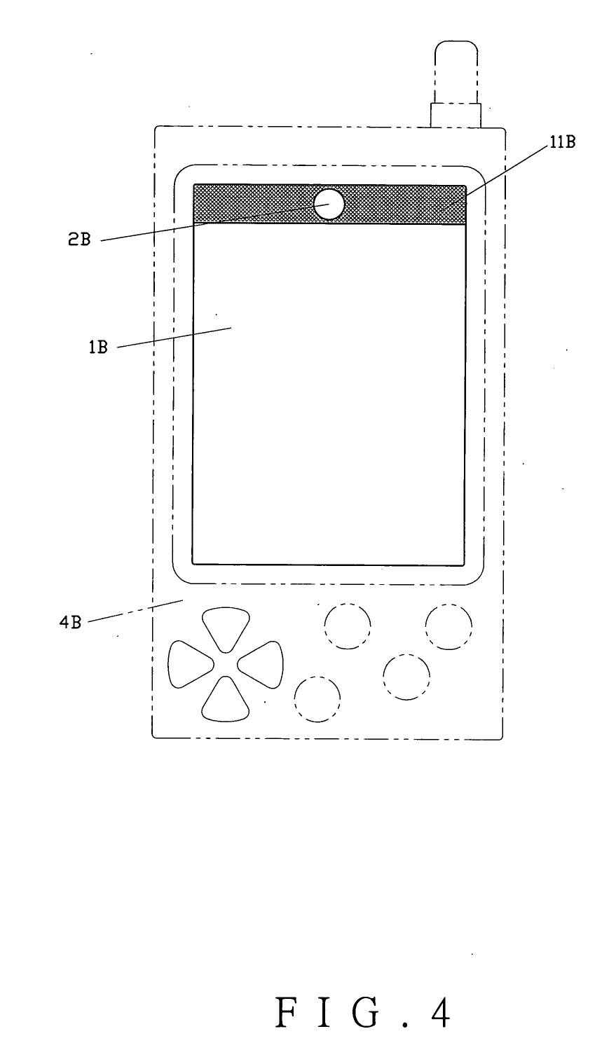

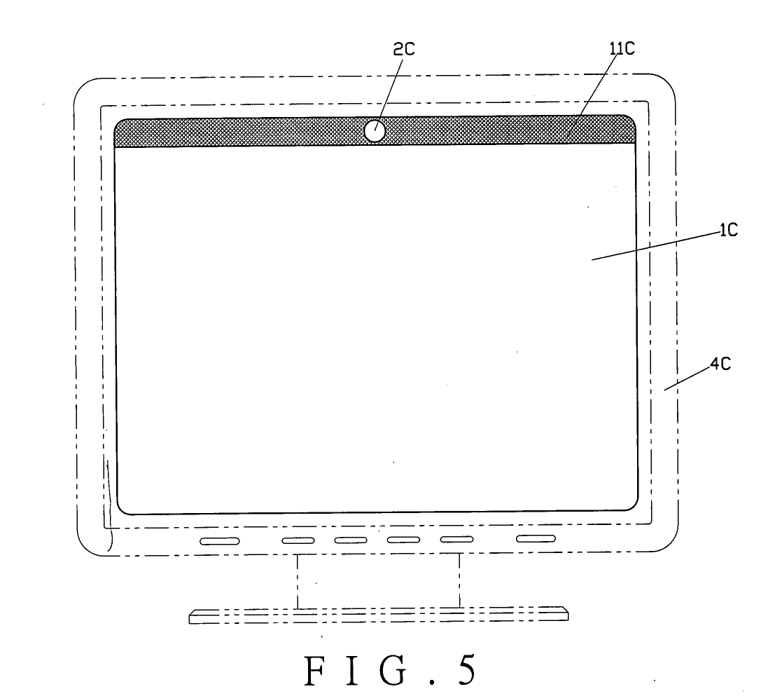

When applied, the display panel (1) of the present invention may be a flat display or other types of display including LCD (liquid crystal display), PDP (plasma display panel), FED (field emission display), LCOS (liquid crystal on silicon), OLED (organic light-emitting diode), and EL (electro luminescent display) applied to PC, TV set, cellular phone or monitor system. As illustrated in FIGS. 3, 4, and 5 in sequence for the schematic views of the present invention respectively applied to a cellular phone, PDA, and LCD, support members (4A, 4B, 4C) including frames of display panels (1A, 1B, 1C) are respectively provided to their respective casings of the finished products; and camera lenses (2A, 2B, 2C) are respectively disposed with their respective extension areas (11A, 11B, 11C) of the surface plates of the display panels (1A, 1B, 1C).

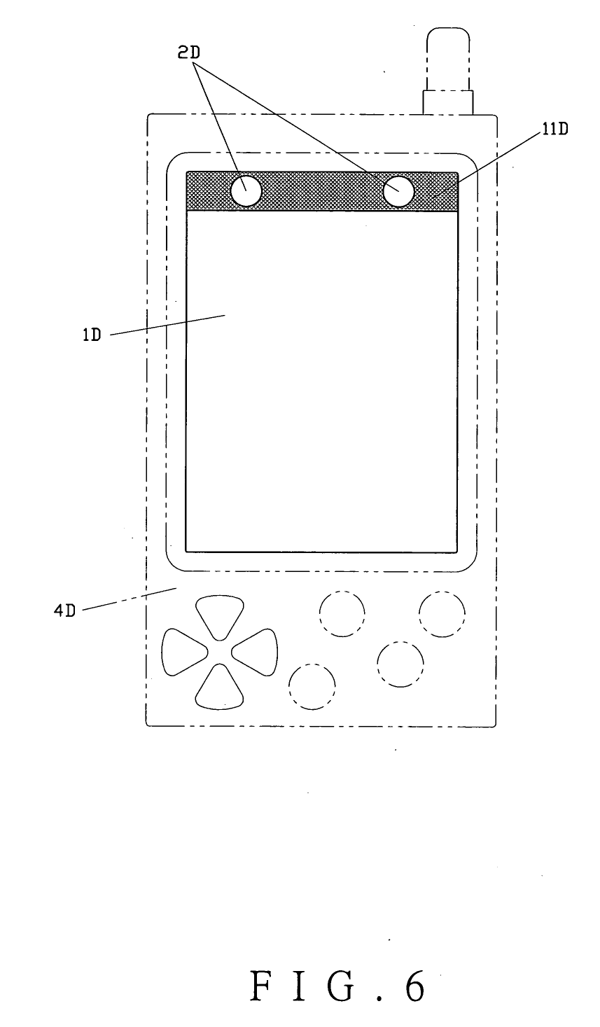

As illustrated in FIG. 6, the present invention is applied to a product provided with dual-lens. A casing of an LCD functions as a support member (4D) (including the frame of a display panel (1D)). Two camera lenses (2D) are disposed within an extension area (11D) of the surface plate of the display panel (1D). The user while conducting a videoconference may provide 3D life-like images.

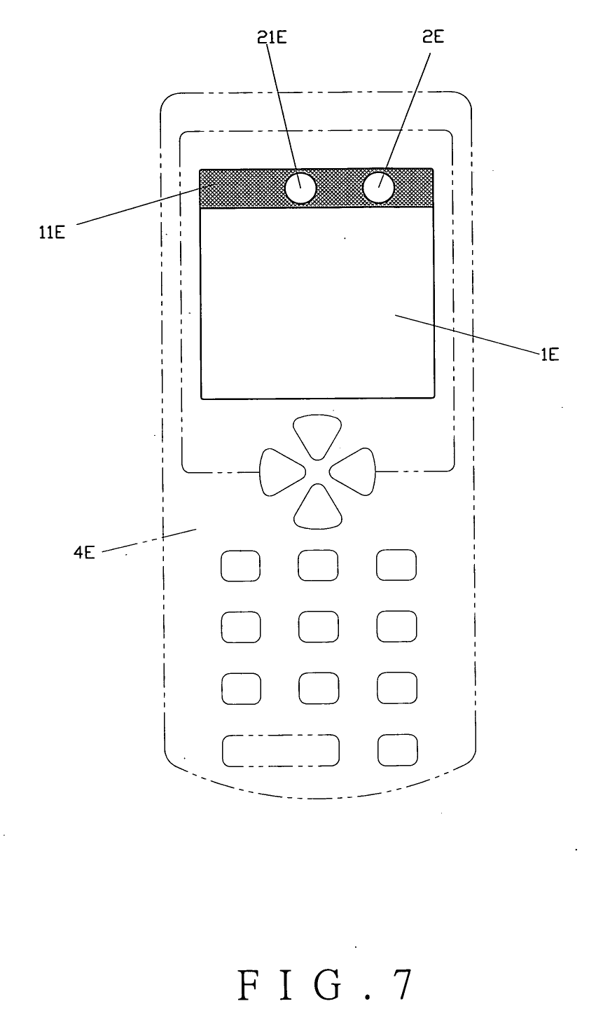

Now referring to FIG. 7 for a schematic view showing that the present invention is applied to a finished product provided with a photoflash. A casing of a cellular phone functions as a support member (4E) (including the frame of a display panel (1E)). A camera lens (2E) and a lighting member (21E) are disposed within an extension area (11E) of the surface plate of the display panel (1E). The lighting member (21E) may be a photoflash or a LED (light emitting diode).

What is claimed is:

1. A display panel with camera function comprising an extension area provided to a surface plate of the display panel and a camera module built in the extension area.

2. The display panel with camera function of claim 1, wherein the camera module has a circuit integrated with a circuit of a display module, and signals are transmitted through a single signal transmission unit.

3. The display panel with camera function of claim 1, wherein the extension area further comprises two camera modules therein.

4. The display panel with camera function of claim 1, wherein the extension area comprises a lighting device therein.
